(19) United States
(12) Patent Application Publication
(10) Pub. No.: US 2005/0003165 A1
(43) Pub. Date: Jan. 6, 2005

(54) Print ink for antistatic plastic film and antistatic film printed with the ink

(76) Inventor: Kanji Hayashi, Tokyo (JP)

Correspondence Address: McGLEW AND TUTTLE, P.C., SCARBOROUGH STATION, SCARBOROUGH, NY, 10510-0827, US

(21) Appl. No.: 10/829,073

(22) Filed: Apr. 21, 2004

(30) Foreign Application Priority Data
Apr. 22, 2003 (JP) 2003-116922
Feb. 9, 2004 (JP) 2004-031551

(51) Int. Cl. B32B 3/00

(52) U.S. Cl. 428/195.1

(57) ABSTRACT

An antistatic property is provided for the ink used for printing on a transparent or semi-transparent plastic film. A binding component of this ink is a complex composition of two or more polyurethane resins. An excellent antistatic printed material is obtained by making the ink for backing up antistatic. The ink is prepared by adding an antistatic agent comprising a mixed composition of a fatty acid dimethylethyl ammonium ethosulfate and polyoxyethylene alkyl ether to s vehicle binder as an organic solvent solution for an ester-based polyurethane resin comprising a mixed composition of high Tg polymer and low Tg polymer. An antistatic plastic film is obtained by backing up the film with this ink. Thus, the plastic film is antistatic, with improved performance and reduced cost as compared to the conventional method of making a film antistatic. Further the aqueous antistatic print ink is effective in overcoming the environmental contaminations.

### CROSS REFERENCE TO RELATED APPLICATIONS

This application claims the benefit of priority under 35 U.S.C. § 119 of Japanese Application 2003-116922 filed on Apr. 22, 2003, the entire contents of which are incorporated herein by reference.

### FIELD OF THE INVENTION

The present invention relates to antistatic print ink for a transparent or semi-transparent plastic film, and more particularly to ink prepared by giving the antistatic property especially to ink used for backing up and effective for suppressing electrification caused by frictions generated on both surfaces of a plastic film sheet as well as to a transparent or semi-transparent plastic film printed material printed with this ink.

### BACKGROUND OF THE INVENTION

In a case of a plastic film, electrification due to frictions occurs during the laminating process, printing process, and bag-forming process, and there have been introduced various contrivances for preventing the electrification. The examples include a method in which an antistatic agent is kneaded in resin before the resin is processed into a film, and a method in which a surface of the film is coated with an antistatic agent.

### Patent Publication 1

### Japanese Patent Laid-Open Publication No. HEI 05-345351

This publication discloses, for the purpose to provide a film for print laminate having excellent antistatic effect and not spoiling excellent characteristics of the film such as transparency, workability, and the like by kneading an antistatic agent therein, a method of manufacturing a film for print laminate by processing resin with the antistatic agent kneaded therein into a film by means of the calendar method, T-die extrusion method, or solvent casting method, extending the film by means of such a method as the heat roll method, tenter method, or inflation method, and further thermally curing the extended film at a temperature higher than the temperature employed during the extending step.

### Patent Document 2

### Japanese Patent Laid-Open Publication No. HEI 10-058622

This patent document relates to an antistatic barrier film having both the oxygen blocking capability and the electrification preventing capability of the PVA coat film 12, and the antistatic barrier film 10 comprises a PVA coat layer 2 provided on a substrate film 1 or a vapor-deposited film, and a bridge type of antistatic agent coat layer 3 provided on a heat seal film 5 laminated on each other via an adhesive layer 4 or a adhesive resin layer 7, and is characterized in that the bridge type of antistatic agent coat layer 3 constitutes a surface-active antistatic agent coat layer made of a copolymer comprising an acrylic ester having a tetra-ammonium group, an acrylic ester, and a methacrylic ester, polyethylene imine and a glycydil compound.

### SUMMARY OF THE INVENTION

An object of the present invention to provide print ink for a plastic film which is excellent in the antistatic property and does not cause such troubles as bleeding. A further object of the present invention is to provide print ink for a plastic film capable of overcoming the problems of environmental contaminations.

### DESCRIPTION OF THE PREFERRED EMBODIMENT

The present inventor considered that, as a plastic film is often subjected to printing, electrification could be prevented, for the purpose to achieve the objects described above, by giving the antistatic property to print ink spread over an entire surface of the plastic film for backing up. The inventor made hard efforts for achieving the object and completed the invention described hereinafter. The invention provides print ink for a plastic film with an antistatic agent added therein.

In the invention described above, the plastic film is transparent or semi-transparent, and the antistatic print ink is gravure ink for backing up.

In the invention as described above, a main component of a vehicle binder used in the antistatic ink is a complex composition of two or more types of polyurethane resins.

In the invention as described above, the polyurethane is a mixed composition of a water dispersion type of higher Tg polymer and a water dispersion type of lower Tg polymer.

In the invention as described above, ultra-high molecular weight polyvinyl pyrrolidone is added to the mixed composition of polymers as a stabilizer.

In the invention as described above, the antistatic agent is added to the aqueous mixed solution of a complex polyurethane resin and polyvinyl pyrrolidone.

In the invention as described above, the antistatic agent is a mixed aqueous solution of a alkyldimethylamino betaine acetate and an electrolytic metallic salt.

The invention as described above provides a plastic film printed material backed-up by aqueous antistatic print ink.

### Effect

In the above configuration, print ink with an antistatic agent added therein can be used for printing with general printing machines by the conventional printing method. It is most effective when the antistatic agent is added to the ink for backing up, but it is also possible to add the antistatic agent to any other ink depending the printing design. However, the best effectiveness of the antistatic property is achieved when the antistatic property is provided in the whole printed area or in area as close as the whole printed area, and therefore the ink for backing up is most effective. In terms of the printing method, the ink for backing up can be used not only in gravure printing but also in flexographic printing, and there is no restriction over the printing method.

The present invention relates to a vehicle binder for aqueous antistatic print ink such as printing ink for baking up, and aqueous antistatic print ink according to the present invention can be prepared by adding pigments such as titanium oxide to the binder. In the invention of print ink for a plastic film as described above, high Tg polyurethane resin is a polyester product composed of an isophorone diisocyanete and polycaprolactonediol, and in the resin Tg is in the range from 0 to 40° C. On the other hand, low Tg polyurethane resin is a polyester product composed of an isophorone diisocyanate and polyesterdiol, and in this resin, Tg is in the range from −30 to 0° C. The mixing ratio of the aforementioned high Tg resin and low Tg resin is preferably 1:2 by solid weight. This mixing ratio is preferable for avoiding the blocking property on a surface printed with the ink.

In the invention of print ink for a plastic film as described above, the mixing ratio of polyvinyl pyrrolidone to the composite polyurethane acceptable as an appropriate addition rate is in the range from 1:2 to 1:5 by solid weight, and more preferably in the range from 1:2.5 to 1:3. The molecular weight of the polyvinyl pyrrolidone used is in the range from 600,000 to 1,200,000. In the invention for a plastic ink as described above, the mixing ratio of a alkyldimethylamino betaine acetate and an electrolytic metallic salt to be employed for preparation of the antistatic agent is in the range of 95:5 to 90:10, and more preferably in the range from 94:6 to 92:8.

### EXAMPLE 1

Components used for preparation the vehicle binder according to the invention are shown in Table 1 below.

TABLE 1

| | | | |
|---|---|---|---|
| 1 | High Tg polyurethane resin | Solid content % = 35.0% | Liquid A |
| | | water dispersions | |
| 2 | Low Tg polyurethane resin | Solid content % = 34.7% | Liquid B |
| | | water dispersions | |
| 3 | Polyvinyl pyrrolidone | Solid content % = 20% | Liquid C |
| | | aqueous solution | |
| 4 | Antistatic agent | Solid content % = 35.8% | Liquid D |
| | | aqueous solution | |
| 5 | Surface-active agent | Solid content % = 4.0% | Liquid E |
| | | aqueous solution | |

The prescriptions of the vehicle binder according to the invention with the above described liquid A through liquid E are as shown in Table 2.

TABLE 2

| Components | Weight (g) | Solid weight(g) | Solid % |
|---|---|---|---|
| Liquid A | 180 | 63.00 | Approx. 22.24 |
| Liquid B | 360 | 124.92 | 44.10 |
| Liquid C | 300 | 60.00 | 21.18 |
| Liquid D | 90 | 32.22 | 11.37 |
| Liquid E | 78 | 3.12 | 1.10 |
| Total | 1008 | 283.26 (28.10%) | |

### EXAMPLE 2

The titanium oxide white color pigment (for back-up printing) with the 10 to 15 micron grain diameter is added to the vehicle binder aqueous preparation liquid in Example 1. The white color ink for back-up printing is prepared by setting the addition rate to 35% by weight of the preparation liquid.

### EXAMPLE 3

Printing was performed using the white color ink for gravure back-up printing obtained in Example 2 on a corona discharge-treated surface of PET film 12 micron (E-5100) manufactured by Toyobo Co., Ltd. by the engraved gravure printing flatplate (150 lines). The printing rate with the gravure printing machine was 70 m/min and the temperature employed for drying was 60° C. The evaluation results in regards to the adhesiveness and the antistatic effectiveness obtained by sampling once for each 100 m in the flow direction are shown in Table 3 below.

TABLE 3

| | | | | | | Friction |
|---|---|---|---|---|---|---|
| | Rubbing | Tape | Concealment | Leveling | Surface | Electric |
| Sample NO. | (a) | (b) | (c) | (d) | resistance (Ω) | strength (kv) |
| 1 | ◯ | ◯ | ◯ | Δ | 1.8 × 10¹⁰ | 0.0 |
| 2 | ◯ | ◯ | ◯ | Δ | 2.5 × 10¹⁰ | 0.0 |
| 3 | ◯ | ◯ | ◯ | ◯ | 1.6 × 10¹⁰ | 0.0 |
| 4 | ◯ | ◯ | ◯ | ◯ | 1.2 × 10¹⁰ | 0.0 |
| 5 | ◯ | ◯ | ◯ | ◯ | 2.2 × 10¹⁰ | 0.0 |
| 6 | ◯ | ◯ | ◯ | ◯ | 1.4 × 10¹⁰ | 0.1 |
| 7 | ◯ | ◯ | ◯ | Δ | 1.2 × 10¹⁰ | 0.0 |
| 8 | ◯ | ◯ | ◯ | ◯ | 1.2 × 10¹⁰ | 0.1 |
| 9 | ◯ | ◯ | ◯ | Δ | 2.3 × 10¹⁰ | 0.0 |
| 10 | ◯ | ◯ | ◯ | Δ | 1.4 × 10¹⁰ | 0.0 |

(a): Avulsion of ink is checked by grasping the printed material

with both hands and rubbing together the printed surfaces face to face 10 times in order to check avulsion of the ink. (no problem/∘, slightly detached/Δ, partially detached/X)
(b): 18 mm cellophane tape is pressed to the printed surface and then forcefully separated therefrom to check the adhesiveness of the ink.
   (no problem/∘, slightly detached/Δ, partially detached/X)
(c): The printed material is visually checked through newspapers to evaluate the visibility of the printed letters.
   (no visibility/∘, slightly visible/Δ, visible/X)
(d): Uniformity of the printing without unevenness or flow is checked.
   (complete uniformity/∘, slightly uneven/Δ, some flow/X)

### EXAMPLE 4

The white color gravure ink for backing up obtained in Example 2 above is printed over another ink to confirm the mutual adhesiveness and the antistatic property. Like in Example 3, corona discharge-treated surface of the biaxially drawn PET film 12 micron (E-5100) is printed with another ink as a first color with the engraving gravure printing plate (175 lines) in the solid state, and then printed with the white color gravure ink for backing up obtained in Example 2 as a second color by the engraving gravure printing plate (150 lines). The printing rate by the gravure printing machine was 70 m/min, and the temperature for drying was 60° C.

The results of evaluation for the adhesiveness of the ink as well as for the antistatic property are shown in Table 4 below.

TABLE 4

| Target ink | Type of the inks | Name and dilution ratio |
|---|---|---|
| Ink A | General ink | New LP super R39 Cyan |
| | | (40% cut by exclusive use |
| | | medium) |
| Ink B | Non toluene type ink | New LP Fine R39 Cyan |
| | | (40% cut by exclusive use |
| | | medium) |
| Ink C | Aqueous ink | Marine plus G R507 |
| | | elementary cyan |
| | | (20% cut by exclusive use |
| | | solvent) |

Ink A and B are manufactured by TOYO INK MFG Co., Ltd., while ink C is manufactured by DAINIPPON Ink And Chemicals, Incorporated.

The evaluation result of the ink adhesiveness and the antistatic property measured by sampling once for every 100 m in the flow direction are shown in Table 5 below.

TABLE 5

| | | | | | | Friction-charged |
|---|---|---|---|---|---|---|
| | Rubbing | Tape | Concealment | Leveling | Surface | Electrostatic Potential |
| Ink | (a) | (b) | (c) | (d) | resistance (Ω) | (kv) |
| A | ◯ | ◯ | Δ | Δ | 1.5 × 10¹⁰ | 0.0 |
| B | ◯ | ◯ | Δ | Δ | 3.0 × 10¹⁰ | 0.0 |
| C | ◯ | ◯ | Δ | Δ | 7.0 × 10⁹ | 0.0 |

The data in (a), (b), (c) and (d) were collected in the same way as that in Example 3 thereof.

### EXAMPLE 5

The LLDPE(linear low-density polyethylene) film (40 microns) was selected as a sealant film and also the ester adhesive:A-620/A-65 manufactured by Mitsui Takeda Chemicals, Inc. was selected as the adhesive agent for the two-color overprinted material according to the embodiment 4, then the adhesive agent prepared. After a predetermined formula was applied to the ink-printed surface of the printed film and the surface was dried, the corona discharge-treated surface of the sealant film was glued to the sealant film. The engraving gravure printing plate of the dry laminator was of 100 lines and the use rate of the adhesive agent applied after drying was 3 g/m². The printed material was stored for 48 hours in the temperature-controlled room at 40° C. for curing.

### EXAMPLE 6

The lamination strength and heat seal strength of the laminate film produced obtained in Example 5 are shown in Table 7 below, while the results of measurement for the friction-charged electrostatic potential are shown in Table 6.

TABLE 6
1. The friction-charged electrostatic potential (v)
Measurement environment: 23° C., 40% RH

| | | Base | | | |
|---|---|---|---|---|---|
| | Sample | side material | | Sealant side | |
| 1 | PET/aqueous ink | 948→ 305 | ◯ | 854→ 181 | ◯ |
| 2 | | 835→ 274 | ◯ | 800→ 194 | ◯ |
| 3 | | 967→ 530 | Δ | 1057→ 445 | Δ |
| 4 | PET/general ink | 750→ 445 | ◯ | 923→ 355 | ◯ |
| 5 | | 672→ 323 | ◯ | 841→ 297 | ◯ |
| 6 | | 425→ 257 | ◯ | 984→ 480 | Δ |

1. The friction-charged electrostatic potential (v)
Measurement environment; 23° C., 40% RH

| | | Base material | |
|---|---|---|---|
| | Sample | side | Sealant side |
| 1 | PET/aqueous ink | 948→ 305 ◯ | 854→ 181 ◯ |
| 2 | | 835→ 274 ◯ | 800→ 194 ◯ |
| 3 | | 967→ 530 Δ | 1057→ 445 Δ |
| 4 | PET/general ink | 750→ 445 ◯ | 923→ 355 ◯ |
| 5 | | 672→ 323 ◯ | 841→ 297 ◯ |
| 6 | | 425→ 257 ◯ | 984→ 480 Δ |

(measured in 60 sec after the end of friction)

TABLE 7
2. The lamination strength and the heat seal strength

| | | Lamination | Heat seal |
|---|---|---|---|
| | | strength | strength |
| | Sample | [gf/15mm] | [kgf/15 mm] |
| 1 | PET/aqueous ink | 450 | 3.5 |
| | | (base material worn) | (seal worn) |
| 2 | | 370 | 3.4 |
| | | (base material worn) | (seal worn) |
| 3 | | 520 | 3.9 |
| | | (base material worn) | (seal worn) |
| 4 | PET/general ink | 380 | 3.7 |
| | | (base material worn) | (seal worn) |
| 5 | | 570 | 3.8 |
| | | (base material worn) | (seal worn) |
| 6 | | 480 | 3.6 |
| | | (base material worn) | (seal worn) |

In Examples 1 through 6 described above, the printing ink is gravure ink, the printing machines is a gravure printing machine, and the ink for backing-up is used. However, the present invention is not limited to these cases as long as electrification can be prevented.

### EFFECTS OF THE INVENTION

The present invention as described above could give the antistatic property to the plastic films printed with the ink. A printed material with excellent antistatic property can be obtained by giving the antistatic property especially to the ink for backing up. Additionally, the antistatic property can be given to the plastic film during the printing process, so that the performance can be improved with the cost reduced more as compared to the conventional method for preventing electrification of a plastic film. Further the aqueous antistatic print ink according to the present invention is effective in overcoming the environmental contaminations.

With the present invention of antistatic print ink as described above, in the antistatic print ink, a resin component of the vehicle binder is ester-based polyurethane resin capable of being dissolved in an organic solvent.

The present invention of plastic ink for a plastic film as described above, the ester-based polyurethane resin is a mixed composition of a high Tg polymer and a low Tg polymer each based on an organic solvent.

The invention of the print ink for a plastic film as described above, the antistatic agent for the ester-based polyurethane as described above is added to an organic solvent solution.

The invention of the print ink for a plastic film, the antistatic agent described above is a mixed composition of fatty acid dimethylethyl ammonium ethosulfate and polyoxyethylene alkyl ether.

The present invention is a plastic film printed material which is backed up with the antistatic print ink based on an organic solvent.

### Effect

In the invention as described above, the print ink with an antistatic agent added therein can be used for printing with general printing machines by the conventional printing method. For printing, it is most effective to add the antistatic agent to the ink for backing up, but it is also possible to add the antistatic agent to any other ink. However, the best effectiveness of the antistatic property is achieved when the antistatic property is provided in the whole printed area or in area as close as the whole printed area, and therefore the ink for backing up is most effective. In terms of the printing method, the ink for backing up can be used not only in gravure printing but also in flexographic printing, and there is no restriction over the printing method.

The present invention provides the antistatic print ink based on an organic solvent, which is a vehicle binder for print ink for backing up, and it is possible to prepare the antistatic print ink based on an organic solvent can be prepared by mixing, for example, a pigment such as titanium oxide and a solvent in this binder. The resin component of the vehicle binder is ester-based polyurethane resin capable of being dissolved in an organic solvent, and this resin is a mixed composition of a high Tg polymer and a low Tg polymer. The high Tg polyurethane resin is in the range from Tg=0 to 40° C. On the other hand, the low Tg polyurethane resin is in the range of Tg=−30 to 0° C. The mixing ratio of the high Tg resin and the low Tg resin in in the range from 1:5 to 1:1 by solid weight, and more preferably is in the range from 1:2 to 1:2.5.

The antistatic agent according to the present invention is a mixed composition of fatty acid dimethylethyl ammonium ethosulfate and polyoxyethylene alkyl ether, and the mixed ratio is in the range from 8:1 to 15:1 by solid weight, and more preferably is in the range from 10:1 to 12:1.

### EXAMPLE 7

Components of the vehicle binder preparation according to the invention are shown in Table 8 below.

TABLE 8

| | | | |
|---|---|---|---|
| 1 | High Tg polyurethane resin | Solid content % = 30. 0% | Liquid A |
| | | ethyl acetate solution | |
| 2 | Low Tg polyurethane resin | Solid content % = 30.0% | Liquid B |
| | | ethyl acetate solution | |
| 3 | Antistatic agent | Solid content % = 30.0% | Liquid C |
| | | ethyl acetate solution | |

Hereunder, the prescriptions of the vehicle binder with the above described liquid A through liquid C are shown in table 9.

TABLE 9

| Components | Quantity(g) | Solid weight (g) | Solid % |
|---|---|---|---|
| Liquid A | 200 | 60.0 | Approx. 29.76 |
| Liquid B | 400 | 120.0 | 59.52 |
| Liquid C | 72 | 21.6 | 10.71 |
| Total | 672 | 201.6 | |

### EXAMPLE 8

The titanium oxide white color pigment (for back up printing) with the 10 to 15 micron grain diameter was added to the prepared vehicle binder aqueous obtained in Example 7. The white color ink for backing up was prepared by adding 35 portions of the pigment to 65 portions of the prepared solution (solution prepared by diluting 15 portions of the solution containing the components as shown in Table 2 above to 50 portions of the IPA/ethyl acetate mixed solution).

### EXAMPLE 9

Printing was carried out using the white color ink(a) for gravure back-up printing obtained in Example 8 and NEW-LP super white ink (urethane based) (b) manufactured by TOYO INK MFG. Co., Ltd. on the surface of the corona discharge-treated surfaces of the following films; the biaxially drawn PET film 12μ (E-5100) manufactured by Toyobo Co., Ltd.; the biaxially drawn nylon film 15 μ (emblem ONU)manufactured by Unitika co., Ltd.; and the biaxially drawn_PP film 20μ(FOR) with the engraving gravure printing plate (50 lines) in the solid state. The printing rate with the gravure printing machine is was 120 m/min, and the temperature employed for drying was 60° C. Table 10 shows a result obtained for the adhesion and antistatic property of the ink at five positions by sampling once for every 5 m of the biaxially drawn PET film 12 μin the flow direction at 5 position.

TABLE 10
(20° C., 51% RH)

| | | | | | | Friction |
|---|---|---|---|---|---|---|
| | Rubbing | Tape | Concealment | Lebeling | Surface | Electric |
| Sample NO. | (*1) | (*2) | (*3) | (*4) | resistance (Ω) | Strength (kv) |
| a1 | ◯ | ◯ | ◯ | ◯ | 7.2 × 10⁸ | 0.0 |
| a-2 | ◯ | ◯ | ◯ | ◯ | 6.8 × 10⁸ | 0.2 |
| a-3 | ◯ | ◯ | ◯ | ◯ | 7.3 × 10⁸ | 0.1 |
| a-4 | ◯ | ◯ | ◯ | ◯ | 6.5 × 10⁸ | 0.0 |
| a-5 | ◯ | ◯ | ◯ | ◯ | 7.0 × 10⁸ | 0.1 |
| b-1 | ◯ | ◯ | ◯ | ◯ | 1.8 × 10¹⁰ | 2.3 |
| b-2 | ◯ | ◯ | ◯ | ◯ | 1.2 × 10¹⁰ | 1.9 |
| b-3 | ◯ | ◯ | ◯ | ◯ | 4.5 × 10¹⁰ | 3.0 |
| b-4 | ◯ | ◯ | ◯ | ◯ | 3.4 × 10¹⁰ | 2.0 |
| b-5 | ◯ | ◯ | ◯ | ◯ | 2.0 × 10¹⁰ | 1.8 |

Further, the results obtained for the biaxially drawn nylon film 15μ are shown in Table 11.

TABLE 11
(20° C., 51% RH)

| | | | | | | Friction-charged |
|---|---|---|---|---|---|---|
| Sample | Rubbing | Tape | Concealment | Leveling | Surface | Electrostatic |
| NO. | (*1) | (*2) | (*3) | (*4) | resistance (Ω) | potential (kv) |
| a1 | ◯ | ◯ | ◯ | ◯ | 6.3 × 10⁸ | 0.0 |
| a-2 | ◯ | ◯ | ◯ | ◯ | 6.5 × 10⁸ | 0.0 |
| a-3 | ◯ | ◯ | ◯ | ◯ | 7.4 × 10⁸ | 0.1 |
| a-4 | ◯ | ◯ | ◯ | ◯ | 6.2 × 10⁸ | 0.0 |
| a-5 | ◯ | ◯ | ◯ | ◯ | 6.2 × 10⁸ | 0.0 |
| b-1 | ◯ | ◯ | ◯ | ◯ | 1.8 × 10¹⁰ | 5.3 |
| b-2 | ◯ | ◯ | ◯ | ◯ | 1.8 × 10¹⁰ | 6.9 |
| b-3 | ◯ | ◯ | ◯ | ◯ | 1.5 × 10¹⁰ | 4.8 |
| b-4 | ◯ | ◯ | ◯ | ◯ | 3.3 × 10¹⁰ | 5.1 |
| b-5 | ◯ | ◯ | ◯ | ◯ | 3.3 × 10¹⁰ | 5.0 |

Furthermore, the results obtained for the biaxially drawn PP film 20μ are shown in Table 12.

TABLE 12
(20° C., 51% RH)

| | | | | | | Friction-charged |
|---|---|---|---|---|---|---|
| Sample | Rubbing | Tape | Concealment | Leveling | Surface | Electrostatic |
| NO. | (*1) | (*2) | (*3) | (*4) | resistance (Ω) | potential (kv) |
| a1 | ◯ | ◯ | ◯ | ◯ | 6.3 × 10⁸ | 0.0 |
| a-2 | ◯ | ◯ | ◯ | ◯ | 6.5 × 10⁸ | 0.0 |
| a-3 | ◯ | ◯ | ◯ | ◯ | 7.0 × 10⁸ | 0.1 |
| a-4 | ◯ | ◯ | ◯ | ◯ | 7.0 × 10⁸ | 0.0 |
| a-5 | ◯ | ◯ | ◯ | ◯ | 6.8 × 10⁸ | 0.0 |
| b-1 | ◯ | ◯ | ◯ | ◯ | 1.8 × 10¹⁰ | 0.8 |
| b-2 | ◯ | ◯ | ◯ | ◯ | 1.2 × 10¹⁰ | 0.7 |
| b-3 | ◯ | ◯ | ◯ | ◯ | 1.6 × 10¹⁰ | 0.9 |
| b-4 | ◯ | ◯ | ◯ | ◯ | 1.5 × 10¹⁰ | 0.8 |
| b-5 | ◯ | ◯ | ◯ | ◯ | 1.8 × 10¹⁰ | 0.8 |

(*1): Avulsion of ink is checked by grasping the printed material with both hands and rubbing together the printed surfaces face to face 10 times in order to check avulsion of the ink. (no problem/◯, slightly detached/Δ, partially detached/X)
(*2): 18 mm cellophane tape is pressed to the printed surface and then forcefully separated therefrom to check the adhesiveness of the ink. (no problem/◯, slightly detached/Δ, partially detached/X)
(*3): The printed material is visually checked through newspapers to evaluate the visibility of the printed letters. (no visibility/◯, slightly visible/Δ, visible/X)
(*4): Uniformity of the printing without unevenness or flow is checked. (complete uniformity/◯, slightly uneven/Δ, some flow/X)

### EXAMPLE 10

The white color gravure ink for backing up obtained in Example 8 is printed over another ink to check the mutual adhesiveness and the antistatic property. Like in Example 9, the corona discharge-treated surface of the biaxially drawn PET film 12μ (E-5100) manufactured by Toyobo Co., Ltd. is printed using another ink as the first color with the engraving gravure printing plate (175 lines) in the solid state, and then printed using the white color gravure ink for backing up obtained in Example 2 as the second color with the engraving gravure printing plate (150 lines). The printing rate with the gravure printing machine was 120 m/min, and the temperature employed for drying was 60° C.

Table 13 shows the adhesiveness of the ink and the antistatic property of the printed materials.

TABLE 13

| Other inks | Type of the inks | Name and dilution ratio |
|---|---|---|
| Ink A | General ink | New LP super R39 Cyan |
| | | (40% cut by exclusive use medium) |
| Ink B | Non toluene type ink | New LP Fine R39 Cyan |
| | | (40% cut by exclusive use medium) |
| Ink C | Aqueous ink | Marine plus G R507 elementary |
| | | cyan |
| | | (20% cut by exclusive use |
| | | solvent) |

Ink A and B are manufactured by TOYO INK MFG. Co., Ltd., while ink C is manufactured by DAINIPPON Ink And Chemicals, Incorporated.

Table 14 shows the adhesiveness of the ink and the antistatic property of the printed materials.

TABLE 14

| | | | | | | Friction-charged |
|---|---|---|---|---|---|---|
| | Rubbing | Tape | Concealment | Leveling | Surface | Electrostatic |
| INK | (*1) | (*2) | (*3) | (*4) | resistance (Ω) | potential (kv) |
| A | ◯ | ◯ | ◯ | ◯ | 1.8 × 10¹⁰ | 0.0 |
| B | ◯ | ◯ | ◯ | ◯ | 1.2 × 10¹⁰ | 0.0 |
| C | ◯ | ◯ | ◯ | ◯ | 1.2 × 10¹⁰ | 0.0 |

### EXAMPLE 11

The films listed at Table 15 were selected each as a sealant film and the ester based adhesive manufactured by Mitsui Takeda Chemicals, Inc. was selected as the adhesive agent for preparation according to the mixing ratio shown in Table 16.

TABLE 15

| Film type | Thickness | Manufacturer | Product name |
|---|---|---|---|
| LLDPE | 40μ | Toyobo co., ltd. | LIX film |
| linear low-density | | | L4102 |
| polyethylene | | | |

TABLE 16

| | Product name | Blending quantity | Solid density |
|---|---|---|---|
| Base resin | A-620 | 16.0 kg | 60% |
| Hardener | A-65 | 1.0 kg | 100% |
| Solvent | ethyl acetate | 18.3 kg | 0% |
| Total | | 35.3 kg | 30% |

The prepared adhesive agent was applied on the surface of printed film printed with the ink, and after the printed surface was dried, it was glued together with the corona discharge-treated surface of the sealant film. The engraving gravure printing plate of the dry laminator was of 100 lines and the volume of the adhesive agent after drying was 3 g/m². The adhesive was left for 48 hours in the temperature-controlled room at 40° C. for curing. Table 17 shows the measurement result of the lamination strength of the layered films glued as described above.

TABLE 17
(g/15 mm)

| | Film | | |
|---|---|---|---|
| Type of ink | configuration | Strength | Description |
| (a) white ink for gravure | PET/LLDPE | 110 | |
| back print according to | NY/LLDPE | 590 | |
| embodiment 8 | OPP/LLDPE | 328 | Film torn |
| (b) NEW-LP super white | PET/LLDPE | 108 | |
| ink | NY/LLDPE | 800 | |
| | OPP/LLDPE | 318 | Film torn |

Further the measurement result for the heat seal strength of the glued laminated film is shown in Table 18 below.

TABLE 18
(g/15 mm)

| | Film | Heat seal temperature | | |
|---|---|---|---|---|
| Type of ink | configuration | 130° C. | 140° C. | 150° C. |
| (a) white ink for gravure | PET/LLDPE | 4.01 | 4.31 | 4.41 |
| back print according to | NY/LLDPE | 5.01 | 5.12 | 5.15 |
| embodiment 8 | OPP/LLDPE | 3.24 | 3.06 | 3.81 |
| (b) NEW-LP super white | PET/LLDPE | 4.01 | 4.40 | 4.61 |
| ink | NY/LLDPE | 5.31 | 5.26 | 5.65 |
| | OPP/LLDPE | 3.17 | 3.21 | 3.79 |

*heat seal condition/0.2 MPa, 0.5 sec, under bar 70° C.

Further, Table 19 shows the measurement result of the glued layered films in terms of the surface resistance.

TABLE 19

| Type of | Film | | |
|---|---|---|---|
| ink | configuration | Substrate front side | Sealant back side |
| (a) | PET/LLDPE | 1.0 × 10¹² and above | 1.0 × 10¹² and above |
| | NY/LLDPE | 1.0 × 10¹² and above | 1.0 × 10¹² and above |
| | OPP/LLDPE | 1.0 × 10¹² and above | 1.0 × 10¹² and above |
| (b) | PET/LLDPE | 1.0 × 10¹² and above | 1.0 × 10¹² and above |
| | NY/LLDPE | 1.0 × 10¹² and above | 1.0 × 10¹² and above |
| | OPP/LLDPE | 1.0 × 10¹² and above | 1.0 × 10¹² and above |

Further, Table 20 shows the measurement result of the glued layered films in terms of the charged value.

TABLE 20
(kv)

| | Film | | |
|---|---|---|---|
| Type of ink | configuration | Substrate front side | Sealant back side |
| (a) | PET/LLDPE | 0.4˜0.6 | 0.4˜0.6 |
| | NY/LLDPE | 0.3˜0.5 | 0.3˜0.5 |
| | OPP/LLDPE | 0.0˜0.1 | 0.0˜0.1 |
| (b) | PET/LLDPE | 5.5˜11.3 | 6.1˜10.3 |
| | NY/LLDPE | 9.1˜12.3 | 11.1˜14.2 |
| | OPP/LLDPE | 0.9˜1.5 | 1.1˜2.3 |

From each of the above results, it is understood that it is possible to sufficiently achieve the antistatic property by using the print ink according to the present invention without lowering the quality as printed materials.

### EFFECT OF THE INVENTION

In the present invention as described above, the antistatic property is provided to a plastic film during the printing process, by carrying out, for instance, back-up printing with the print ink with an antistatic agent added therein according to the present invention. The print ink with an antistatic agent added therein does not cause bleeding troubles as experienced in the conventional technology, in which an antistatic agent is kneaded in resin, especially when the print ink is used for backing up, so that deterioration in printing quality can be avoided. Further, different from the conventional system in which a surface of a film is coated with an antistatic agent, the antistatic property is given during the printing process in this invention, so that the coating step can be omitted, and cost reduction can be realized for plastic film products having the antistatic property.

1. A print ink for a plastic film, the print ink comprising:
an antistatic agent added therein.

2. A print ink for a plastic film according to claim 1, wherein the plastic film is transparent or semi-transparent, and the print ink, which is antistatic, is a gravure ink for backing up.

3. A print ink according to claim 1, further comprising:
a main component of a vehicle binder, the main component being a complex composition of two or more types of polyurethane resins.

4. A print ink for a plastic film according to claim 3, wherein said polyurethane resin is print ink comprising a mixed composition of a water dispersion type of high Tg polymer and a water dispersion type of low Tg polymer.

5. A print ink for a plastic film according to claim 4, wherein a polymeric mixed composition of said water dispersion type of high Tg polymer and said water dispersion type of low Tg polymer, further comprises:
an ultra-high molecular weight polyvinyl pyrrolidone added therein as a stabilizer.

6. A print ink for a plastic film according to claim 1, wherein said antistatic agent is added to an aqueous mixed solution of a complex polyurethane resin and polyvinyl pyrrolidone.

7. A plastic ink according to claim 6, wherein said antistatic agent is a mixed aqueous solution of a alkyldimethyl betaine acetate and an electrolytic metallic salt.

8. A plastic film and print ink combination, comprising:
a transparent or semi-transparent plastic film printed material; and
an aqueous antistatic print ink, said plastic film printed material being backed up by said aqueous antistatic print ink.

9. An print ink according to claim 1, wherein a resin component of said vehicle binder is ester-based polyurethane resin capable of being dissolved in an organic solvent.

10. A plastic ink for a plastic film according to claim 9, wherein said ester-based polyurethane resin is a mixed composition of a high Tg polymer and a low Tg polymer each based on an organic solvent.

11. A print ink for a plastic film according to claim 10, wherein an antistatic agent including said ester-based polyurethane resin is added to an organic solvent solution for the ester-based polyurethane.

12. A print ink for a plastic film according to claim 11, wherein said antistatic agent is a mixed composition of fatty acid dimethylethyl ammonium ethosulfate and polyoxyethylene alkyl ether.

13. A transparent or semi-transparent plastic film printed material backed up with the antistatic print ink based on an organic solvent.

14. A print ink and plastic film combination, comprising:
a plastic film; and
a print ink with an antistatic agent added therein.

15. A print ink and plastic film combination according to claim 14, wherein the plastic film is transparent or semi-transparent, and the print ink, which is antistatic, is a gravure ink for backing up.

16. A print ink and plastic film combination according to claim 15, further comprising:
a main component of a vehicle binder, the main component being a complex composition of two or more types of polyurethane resins.

17. A print ink and plastic film combination according to claim 16, wherein said polyurethane resin is print ink comprising a mixed composition of a water dispersion type of high Tg polymer and a water dispersion type of low Tg polymer.

18. A print ink and plastic film combination according to claim 16, wherein a polymeric mixed composition of said water dispersion type of high Tg polymer and said water dispersion type of low Tg polymer, further comprises:
an ultra-high molecular weight polyvinyl pyrrolidone added therein as a stabilizer.

19. A print ink and plastic film combination according to claim 14, wherein said antistatic agent is added to an aqueous mixed solution of a complex polyurethane resin and polyvinyl pyrrolidone.

20. A print ink and plastic film combination according to claim 19, wherein said antistatic agent is a mixed aqueous solution of an alkyldimethyl betaine acetate and an electrolytic metallic salt.
